(19) United States
(12) Patent Application Publication
(10) Pub. No.: US 2011/0102442 A1
(43) Pub. Date: May 5, 2011

(54) Recording Contents of Display Screens

(76) Inventors: Ahmed Rafeek Bin Ahmad Ibrahim, Georgetown (MY); Wee Hoo Cheah, Bayan Lepas (MY)

(21) Appl. No.: 12/611,992

(22) Filed: Nov. 4, 2009

(51) Int. Cl. G06T 1/00; G09G 5/36

(52) U.S. Cl. 345/501; 345/547; 345/555

(57) ABSTRACT

Screen recording may be implemented with better security, performance, power savings and cost without the need of additional software to support the screen recording feature, in some embodiments, by using a keyboard, video, mouse functionality already provided in a computer system chipset on a motherboard. Frames of video may be stored on that system or, in some cases, may be selectively provided to a local area network.

### BACKGROUND

This relates generally to computers and, particularly, to computers with the ability to capture and record screen images.

Conventionally, screen images may be captured for a variety of purposes. For example, screen recording may be useful in business, training, tutorials, manuals, websites, education, and the like. Generally, screen activity is dynamically recorded in a video format and stored on a hard disk drive for later use.

Conventionally, the screen recording feature is available through the use of software applications. These software applications must be purchased and, therefore, entail additional costs.

### BRIEF DESCRIPTION OF THE DRAWINGS

FIG. 1 is a hardware depiction of one embodiment of the present invention; and

FIG. 2 is a flow chart for one embodiment of the present invention.

### DETAILED DESCRIPTION

In accordance with some embodiments, the performance and security of screen recording may be improved by using existing chipset infrastructure or hardware in personal computers. As used herein, a “chipset” is one or more microchips that work together on a motherboard to allow computer components to communicate. Thus, compared to software solutions, using a chipset solution may be less central processor unit intensive in some embodiments. As a result, power savings may be achieved in some embodiments. In addition, in some embodiments, costs may be saved to users since they do not need to purchase additional software to enable screen recording.

A chipset that is part of the processor hardware that has a frame grabbing feature integrated in the hardware can be used to provide screen recording. For example, a keyboard, video, mouse (KVM) functionality is embedded within the Intel® brand P55 Express Chipset, also called a platform controller hub (PCH). Thus, in some embodiments, such a keyboard, video, mouse functionality may be used for a new purpose to provide screening recording, a purpose never provided by such embedded functionality in the past.

A keyboard, video, mouse (KVM) functionality enables a user to control another computer through a remote keyboard, video display unit, or mouse or, conversely, enables a user to access a single computer from multiple monitors, keyboards, or mice. Conventionally, the KVM functionality is implemented by a dedicated hardware switch, but software for implementing the KVM functionality is also available. Thus, it enables remote control of any computer. In the existing Intel® brand chipsets, the keyboard, video, mouse functionality provides encrypting compressed data over a local area network (LAN). In some embodiments, this keyboard video mouse functionality may be used for screen recording by storing compressed frames of video information in a storage on board the same system with the chipset.

In some embodiments, the chipset keyboard video mouse infrastructure streams and compresses live screen activities captured through a local area network for manageability purposes. This keyboard video mouse infrastructure may be secure for manageability reasons in some embodiments.

This same data may be routed to storage in any video format for screen recording purposes. For example, the Intel® brand chipset manageability subsystem allows this capability to be routed through a local area network. The same data may be routed to a virtualization engine or controller to be stored on a system hard disk drive.

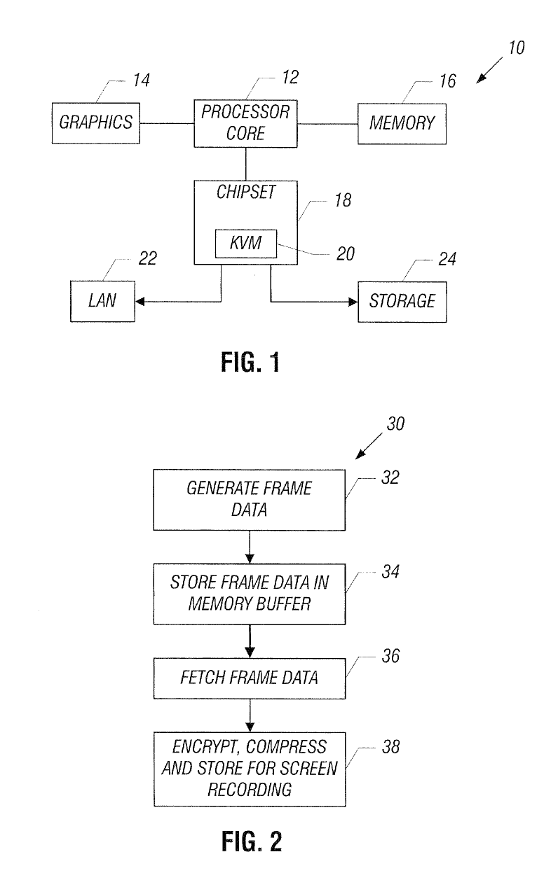

Thus, referring to FIG. 1, in accordance with one embodiment, a processor-based system 10 may be any processor-based system. For example, it may be a personal computer, a telephone, a set top box, a server, a laptop computer, a video recording device, a mobile Internet device (MID) or any other processor-based system. In one embodiment, the system 10 may include a processor core 12, coupled to system memory 16 and a graphics system 14, such as a graphics processing unit.

The processor core 12 may also be coupled to a chipset 18. In one embodiment, the chipset is the Intel P55 Express Chipset available from Intel Corporation, Santa Clara, Calif. The chipset 18 may have hardware keyboard video mouse 20. Thus, the chipset includes a keyboard video mouse function which provides stored video to a local area network 22. Other examples of chipsets that could include a KVM functionality include a north bridge, south bridge, I/O controller hub, platform controller hub, integrated memory controller, or memory controller hub, as examples.

In accordance with some embodiments of the present invention, that stored video may also be routed to a storage 24 on the system 10. In one embodiment, the storage 24 may be a hard disk drive, but any storage may be utilized for this purpose.

Referring to FIG. 2, in accordance with some embodiments, the graphics system 14 generates frame data, as indicated in block 32 in sequence 30. The frame data may be stored in a memory buffer, as indicated in block 34. For example, the frame data may be stored in the memory 16 in one embodiment.

A check at diamond 35 determines whether or not the KVM functionality or screen recording functionality has been selected. The selection could be received from a user input device, processed and provided for execution by the processor core or even on board the chipset 18 in some embodiments.

If the data is intended for use in connection with a KVM function, over the local area network, then the data is encrypted, compressed, and sent over the local area network 22, as indicated in block 39.

Otherwise, if the KVM functionality was not selected, but, instead, the screen recording functionality was selected, then a series of frames may be designated by a user selection. In other words, the user may indicate a time sequence of frames for which recording may be undertaken. For example, the user may use a user interface to indicate a starting frame for screen recording and then a last frame for screen recording. Alternatively, the user can simply select screen recording until screen recording is turned off by de-selection. In one embodiment, the user may be provided with a user interface with thumbnails showing a series of frames that the user can select for screen recording. Alternatively, the user can select each displayed screen for recording or not.

Thus, as an example, in a sequence of using a piece of software, a plurality of display screens may be displayed. The user may be provided a user interface to select screen recording for each screen display. Thus, the screen may show a given user interface, it may be recorded, bringing up another screen display, which may also be recorded if so selected by the user and so on.

Then, the frame data may be fetched by the chipset 18 and, particularly, by the keyboard video mouse 20, as indicated in block 36. Finally, the fetched frame data may be encrypted, compressed, and stored for screen recording, as indicated in block 38. In one embodiment, that storage may be on board the system 10, in the storage 24, for example.

In some embodiments, the sequence 30 may be implemented in hardware. In other embodiments, the sequence 30 may be implemented in part or in whole by software, including a sequence of instructions stored in a computer readable medium. A computer readable medium may be any medium readable by a computer, including a semiconductor memory, a magnetic memory, or an optical memory. Thus, in some embodiments, where software is utilized, the sequence 30 may be implemented by software instructions stored on the storage 24 or even on the memory 16, in some embodiments.

Some embodiments may result in reduced costs to the end purchaser. Also, relying on the chipset shifts from a processor centric to a chipset centric solution which consumes less processing power in some embodiments. Then, in some cases, power consumption may be reduced and performance may be increased with better security.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using a keyboard, video, mouse functionality of a chipset in a computer system to record frames of video; and
storing said frames of video on said system.

2. The method of claim 1 including using a keyboard, video, mouse functionality on a south bridge or peripheral component hub.

3. The method of claim 1 including also enabling said frames to be provided to a local area network.

4. The method of claim 3 including selectively enabling said frames to be provided to a storage on said system or said local area network.

5. The method of claim 1 including generating frame data in a memory on said system.

6. The method of claim 5 including storing said frame data in a memory buffer.

7. The memory of claim 6 including fetching, encrypting, compressing, and storing said frame data for screen recording.

8. A computer readable medium storing instructions executed by a computer to:
use a keyboard, video, mouse functionality of a chipset in a computer system to select frames of video for recording; and
store said frames of video on said system.

9. The medium of claim 8 further storing instructions to use a keyboard, video, mouse functionality on a south bridge or peripheral component hub.

10. The medium of claim 8 further storing instructions to enable said frames to be provided to a local area network.

11. The medium of claim 10 further storing instructions to enable user selection of frames to be provided to a storage on said system or to enable said frames to be provided to a local area network.

12. The medium of claim 8 further storing instructions to generate frame data in a memory on said system.

13. The medium of claim 12 further storing instructions to store said frame data in a memory buffer.

14. The medium of claim 13 further storing instructions to fetch said frame data, encrypt, compress, and store said frame data for screen recording.

15. An apparatus comprising:
a processor core; and
a chipset coupled to said processor core, said chipset including a keyboard, video, mouse functionality, said chipset to selectively implement recording on said apparatus of screen displays or to provide information to a local area network.

16. The apparatus of claim 15 wherein said chipset is a south bridge or peripheral component hub.

17. The apparatus of claim 15, said chipset to enable user selection of frames to be provided to a storage on said system or to enable said frames to be provided to a local area network.

18. The apparatus of claim 15, said chipset to generate frame data in a memory on said apparatus.

19. The apparatus of claim 18, said chipset to store said frame data in a memory buffer.

20. The apparatus of claim 19, said chipset to fetch said frame data, encrypt, compress, and store said frame data for screen recording.
